(19) United States
(12) Patent Application Publication
(10) Pub. No.: US 2005/0173971 A1
(43) Pub. Date: Aug. 11, 2005

(54) Spoke for a bicycle wheel, wheel and method for manufacturing such a spoke, and a sealing element for such a spoke

(75) Inventors: Maurizio Passarotto, Rovigo (IT); Mario Meggiolan, Creazzo (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.r.l., Vicenza (IT)

(21) Appl. No.: 11/044,817

(22) Filed: Jan. 27, 2005

(30) Foreign Application Priority Data
Jan. 27, 2004 (EP) 04425048.8

(51) Int. Cl. B60B 1/02

(52) U.S. Cl. 301/104; 301/58

(57) ABSTRACT

A spoke for a bicycle wheel has an elongated body which extends along an axis, between a first end adapted to be fixed to the rim of the wheel and a second end adapted to be fixed to the hub of the wheel. The spoke has, close to the first end, a zone of width greater than the width of the zone close to the second end.

### FIELD OF INVENTION

The present invention relates to a spoke for a bicycle wheel. More specifically, the invention relates to a spoke for a bicycle wheel made of metallic material, a method for manufacturing such a spoke, a bicycle wheel comprising a plurality of such spokes, and a sealing means that can be used with such a spoke.

### BACKGROUND

Spokes commonly used in bicycle wheels consist of substantially wire-shaped elements, generally made of metal like steel or aluminum, that are mounted between the central part of the wheel consisting of the hub and the rim on which the tire is mounted.

A type of spoke commonly used consists of a cylindrical wire-shaped element, with a diameter in the order of a few millimeters, with a widened head for the attachment in suitable seats of the hub and a threaded head for the attachment, through nipples, to the rim.

During travel, considering the small width of the spokes and therefore the small surface that they occupy in the plane of the wheel in which they are arranged, the rotation of the wheel determines the reduction in visibility of the spokes themselves.

A reduced visibility of the spokes determines the reduction in visibility of the wheel and therefore also the reduction in visibility of the bicycle. Such a fact determines a worsening of the safety conditions for the cyclist, for example when the road being traveled upon is very busy or else in the case of low visibility due to fog.

A known solution proposed to increase the visibility of the wheel consists of the application of plastic plates, possibly colored, on the spoke.

Such a solution, however, has some drawbacks.

A first drawback lies in the fact that plates worsen the aerodynamics of the spoke and of the wheel, as well as increasing the noise, during rotation, due to air turbulence.

Another drawback is represented by the fact that such plates, after a certain period of time and of exposure to atmospheric agents, such as sun or ice, deteriorate and are subject to detachment, thus requiring the replacement thereof. Moreover, the possible detachment of the plates during travel can be dangerous for following cyclists or for the cyclist himself.

Finally, the application of plates is laborious and requires time with the consequent increase of the costs for manufacturing the wheel.

### SUMMARY

The object of the present invention is that of overcoming said drawbacks. A first object of the invention is to manufacture a spoke which allows the visibility of the wheel to be increased without using additional elements. Another object of the invention is that of manufacturing a spoke which allows the aerodynamics of the wheel to be increased and the noisiness to be decreased during rotation. A further object of the invention is that of increasing the visibility of the wheel keeping the weight thereof at low values.

The spoke described herein meets these objects by providing a spoke for a bicycle wheel comprising an elongated body which extends, along an axis, between a first end adapted to be fixed to the rim of the wheel and a second end adapted to be fixed to the hub of the wheel, wherein the spoke has, close to said first end, a zone of a width greater than the width of the zone close to said second end.

Advantageously, the zone of greater width, being provided close to the zone of attachment of the spoke to the rim, where the tangential speed during rotation is greater, allows the visibility effect of the spoke to be increased. The greater tangential speed emphasizes, indeed, the visibility effect of the spoke and of the wheel.

According to a preferred embodiment, the elongated body of the spoke has an elliptical-shaped flattened profile orientated according to the plane of the wheel. In such a way, the aerodynamic coefficient of the spoke and of the wheel improves and the overall weight of the spoke is kept at low values.

### BRIEF DESCRIPTION OF THE DRAWING(S)

Further characteristics and advantages of the invention shall become clearer from the description of some preferred embodiments, given with reference to the attached drawings, where:

FIG. 1 represents a longitudinal view of the spoke of the invention along the longitudinal axis;

FIGS. 1a-1c represent different sections of the spoke of FIG. 1 respectively along the planes AA-AA, BB-BB and DD-DD;

FIG. 2 represents a side view of the spoke of FIG. 1;

FIG. 3 represents a view of a first variant of the spoke of the invention of FIG. 1;

FIGS. 3a-3c represent different sections of the spoke of FIG. 3 respectively along the planes AA-AA, BB-BB and DD-DD;

FIG. 4 represents a side view of the spoke of FIG. 3;

FIG. 5 represents a view of another variant of the spoke of FIG. 1;

FIGS. 5a-5c represent different sections of the spoke of FIG. 5 respectively along the planes AA-AA, BB-BB and DD-DD;

FIG. 6 represents a side view of the spoke of FIG. 5;

FIG. 7 represents a view of another variant of the spoke of FIG. 1;

FIGS. 7a-7c represent different sections of the spoke of FIG. 7 respectively along the planes AA-AA, BB-BB and DD-DD;

FIG. 8 represents a side view of the spoke of FIG. 7;

FIG. 9 represents a view of another variant of the spoke of the invention of FIG. 1;

FIGS. 9a-9c represent different sections of the spoke of FIG. 9 respectively along the planes AA-AA, BB-BB and DD-DD;

FIG. 10 represents a side view of the spoke of FIG. 9;

FIG. 11 represents an axonometric view of the sealing element of the invention that can be used with the spoke of the invention;

FIG. 12 represents a section view along the plane A-A of the sealing element of FIG. 11;

FIG. 13 represents an enlarged detail, in an axonometric view, of the spoke of the invention applied to a rim of a wheel;

FIG. 14 represents a plan view of a wheel equipped with the spokes of the invention of FIG. 1.

### DETAILED DESCRIPTION OF THE PREFERRED EMBODIMENT(S)

### Introduction to the Embodiments

Throughout the present description and the subsequent claims, the term “profile,” used with reference to the cross section of any portion of the spoke of the present invention, is used to indicate the shape defined by the outline of such a cross section. The expression “substantially the same profile”, used with reference to the sections of the spoke of the present invention, is thus used to indicate that such sections have a substantially identical shape, although not necessarily also a substantially identical area. The expression “substantially the same”, used with reference to the profiles of the sections of the spoke of the present invention also embraces the possibility of not total identity of the profiles, for example due to joins, or bevels or tapers. For example, in the context of the present invention, a rectangular profile is to be considered substantially the same as an elliptical profile (or circular with a wide radium of curvature) with opposite faces that are squashed (not necessarily flat) and/or gradually joined.

Throughout the present description and the subsequent claims, the expression “flattened” is used to indicate a portion that has been squashed along the transversal axis Z so that the cross section of such a portion has one dimension (typically defining the thickness of the portion of spoke in question) that is smaller than the other dimension (typically defining the width of the portion of spoke in question). Therefore, the opposite faces of said portion of spoke do not necessarily have to be perfectly flat and parallel; i.e. it is also possible for such faces to have a substantially elliptical progression or a substantially circular progression with a wide radius of curvature.

### Description of the Embodiments

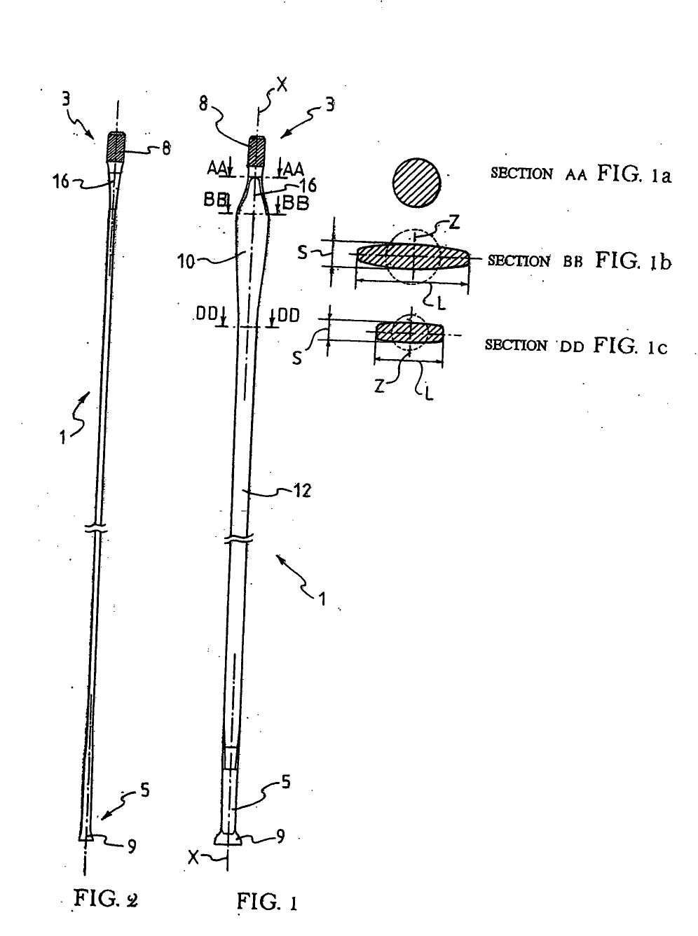

The spoke of the invention is represented in FIGS. 1 and 2 and is wholly indicated with the numeral 1. In FIG. 14 a bicycle wheel W is represented equipped with spokes 1 of such a type.

The spoke 1 has an elongated body 2 which extends along a longitudinal axis X-X. As can be seen more clearly in FIG. 14, the elongated body 2 extends between a first end 3 for the attachment to the rim 4 of the wheel W and a second end 5 for the attachment to the hub 7 of the wheel W. The attachment of the spoke 1 to the rim 4 and to the hub 7 of the wheel W is carried out according to known techniques, better explained hereafter. For such a purpose, the first end 3 is cylindrical and provided with a threading 8, whereas the second end 5 has a suitably widened head 9 shaped to be received in a suitable seat 7a of the hub 7.

The spoke 1 of the invention has, close to the first end zone 3, a zone 10 of a width greater than the second end 5 of the spoke 1. For simplicity of explanation, we shall use for such a zone 10 the expression “high visibility zone” 10. Such a high visibility zone 10 extends along the longitudinal axis X-X for a length equal to about 10% of the total length of the spoke 1 and has in section, as can be seen in FIGS. 1b and 1c, an elliptical flattened profile which defines a width L and a thickness S along a transversal axis Z.

With reference to the sections of FIGS. 1b and 1c, in the high visibility zone 10 of the spoke 1, the width L increases from section DD-DD to section BB-BB. The thickness S also slightly increases from section DD-DD to section BB-BB. Such sections have, in any case, substantially the same profile.

Between section BB-BB and circular section AA-AA, close to the cylindrical threaded end 8 of the first end zone 3, there is also a joining zone 16 in which from the zone with a flattened profile of the high visibility zone 10 one passes to the aforementioned circular zone of section AA-AA. In such a joining zone 16, the width L decreases whereas the thickness S increases, as can be seen more clearly in FIG. 2.

The remaining part of the spoke 1, with respect to the high visibility zone 10, further to the end portion 5, has an intermediate portion 12, both of substantially flattened profile, but such portions could also have a substantially circular profile.

In FIGS. 1a to 1c referring to the sections of the spoke 1 along the longitudinal axis X-X, with the broken line the circumference that defines the equivalent area of the represented area is shown. The equivalent area represents, for each section, the area of a hypothetical non-flattened cylindrical wire which has, in each section, the same area as the spoke 1 with a flattened profile.

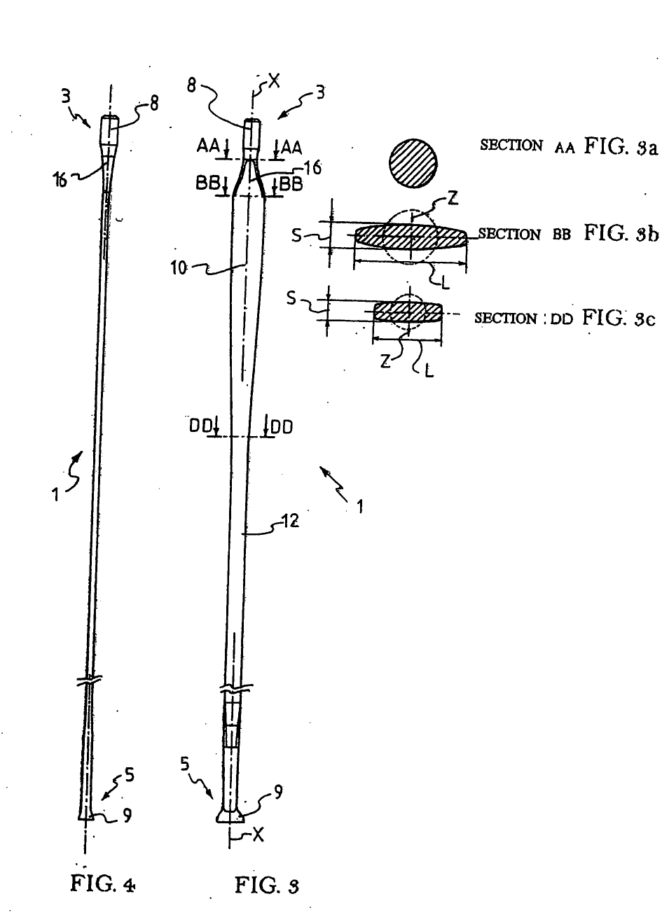

The variant of the spoke 1 represented in FIGS. 3, 4 and from 3a to 3c, differs from the spoke 1 described above for the different extension of the high visibility zone 10 which represents about 30-40% of the total length of the spoke 1. Moreover, the remaining part of the spoke 1, with respect to the high visibility zone 10, as well as the end portion 5, has an intermediate portion 12, both of substantially flattened profile, but such portion could also have a substantially circular profile.

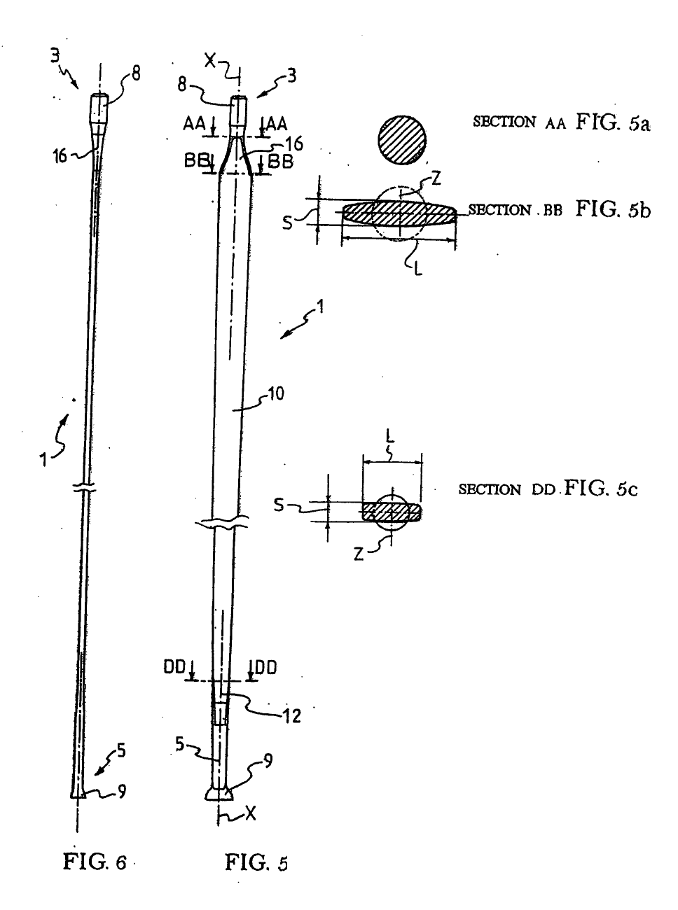

The variant of the spoke 1 represented in FIGS. 5, 6 and from 5a to 5c, differs from the solutions previously described for the fact that the high visibility zone 10 extends up to close to the second end zone 5, i.e. up to the section DD-DD, for a length equal to about 80-90% of the total length of the spoke 1.

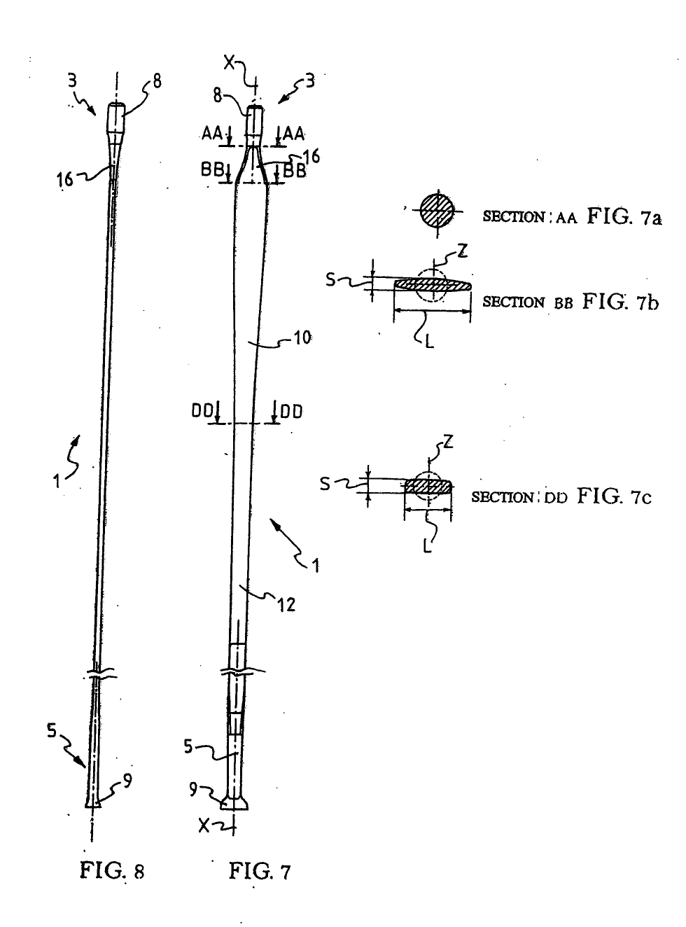

The variant of the spoke 1 represented in FIGS. 7, 8 and from 7a to 7c, has the high visibility zone 10 which extends for a length equal to about 45-50% of the total length of the spoke 1.

Moreover, such a solution differs from the previous ones in that the thickness S of the spoke 1 in the various sections of the high visibility zone 10 starting from section DD-DD up to section BB-BB, continuously decreases. The continuous reduction of the thickness S in the high visibility zone 10 contributes to decreasing the equivalent areas of the spoke in the various sections and thus to decreasing its overall weight. Moreover, such a reduction in thickness allows the coefficient of aerodynamic penetration of the spoke 1 to be increased which, in its position mounted in the wheel, is the part of the spoke subjected to the greatest tangential speed and thus to the greatest friction with air.

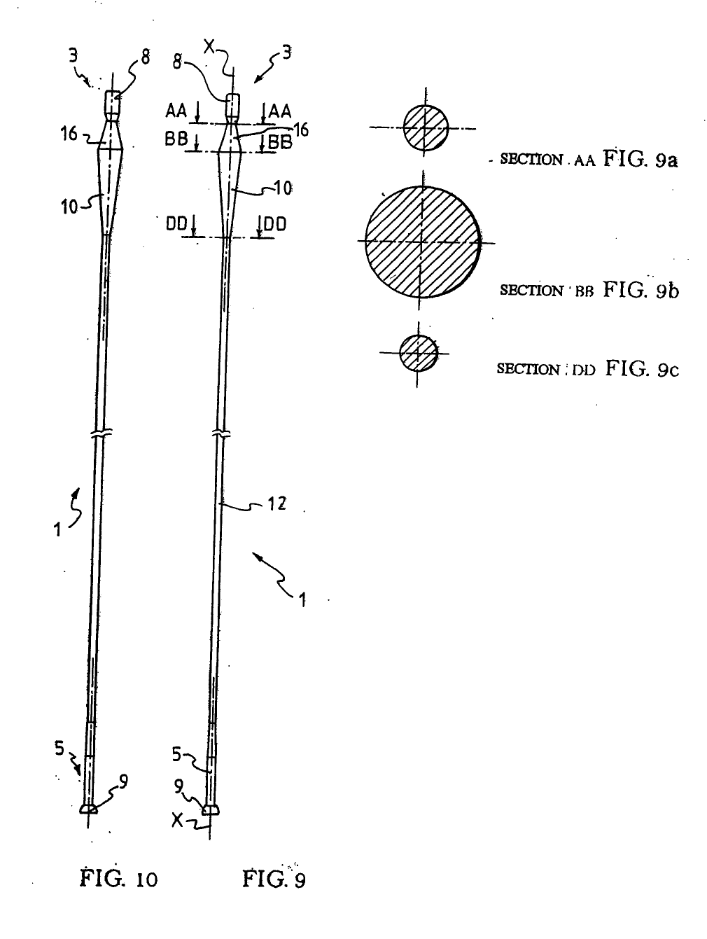

The variant of the spoke 1 represented in FIGS. 9, 10 and from 9a to 9c, has the high visibility zone 10 which extends for a length equal to about 20-25% of the total length of the spoke 1. Such a solution differs from the previous ones in that the high visibility zone 10 has, in each section thereof, a circular profile. The remaining part of the spoke 1, with respect to the high visibility zone 10, further to the end portion 5, has an intermediate portion 12, both with a circular profile, but such portions could also have a flattened profile.

A first method for manufacturing the spokes described and represented in FIGS. from 1 to 8 is described hereafter with reference to FIGS. 1, 2 and from 1a to 1c and can be used to manufacture the spokes in the other Figures.

The first step of the method comprises the cutting of a filament of predetermined length from a wire of metallic material, preferably but not necessarily aluminum, of circular section. The area of the circular section of the wire is chosen equal to the equivalent area of the section of the widened shaped head 9 of the second end 5. The wire is in an annealed state which, as known, gives the wire physical characteristics of deformability particularly suitable for the subsequent processing.

Then follows a step of shaping the filament obtained. The shaping of the filament is obtained through plastic deformation, cold or hot, and preferably through hammering. Such shaping allows a profile with variable geometry to be obtained, preferably with a circular section, between the end zone 3 and the second end zone 5, in which each section has an area equal to the desired equivalent area for the end spoke.

Then there is an optional intermediate annealing heat treatment to promote the reduction in hardness of the material and to increase its deformability.

One then proceeds with the squashing of the filament in the various sections to obtain the desired end elliptical profiles. The squashing is carried out by cold or hot plastic deformation, through mold and counter mold, or else by lamination, i.e. with the passage of the filament between rollers with suitably shaped surfaces.

Then a further optional intermediate annealing heat treatment is carried out to promote the reduction in hardness of the material and to increase its deformability.

Then there is the step of shaping the widened head 9 of the second end 5 through squashing by molding through a mold and counter mold having shapes suitable for giving the head 9 the desired shape. It should be noted that such a step, alternatively, can be carried out at the same time as the previous squashing step of the filament.

One then proceeds to calibrate the length of the spoke, commonly known as butting, which consists of the trimming of the second end 5 to calibrate the total length of the spoke according to the desired final length of the spoke 1.

The filament is then subjected to a drawing temper heat treatment to increase its mechanical characteristics, for example a tempering and drawing process should the metallic material of which the spoke consists be steel, or a tempering and ageing process should aluminum be used.

Then the first end 3 is threaded for attachment to the rim 4. The threading can be carried out by rolling or by a shaving-removal operation. In the case of rolling, the profile of the thread is obtained by plastic deformation of the first end 3 by acting upon a circular section of the filament obtained during the previous shaping step, having a diameter smaller than the outer diameter of the desired threading and equal to about the core diameter. In the case of shaving-removal, the profile of the thread is obtained by removal of material by acting upon a circular section of the filament, obtained during the previous shaping step, having the same diameter as the outer diameter of the threading to be obtained.

Finally, the spoke obtained from the previous processing is subjected to surface protection treatments, such as anodization or painting, which give the spoke the desired properties of surface protection and the desired aesthetic characteristics.

A second method for manufacturing the spokes described and represented in FIGS. from 1 to 8 is described hereafter with reference to FIGS. 1, 2 and from 1a to 1c and can be extended to the remaining solutions.

The first step comprises the cutting of a filament of predetermined length from a wire of metallic material, preferably but not necessarily aluminum of circular section. The wire is in an annealed state which, as known, gives the wire physical characteristics of deformability particularly suitable for the subsequent processing.

The area of the circular section of the wire is chosen equal to the equivalent area of the section of the first end 3 before threading, defined as pre-processing area. Such a pre-processing area shall consist of a circumference of a diameter smaller than the outer diameter of the desired threading in the case in which a subsequent threading by rolling is foreseen, or else it shall consist of a circumference of the same diameter as the outer diameter of the desired threading in the case in which a subsequent threading by shaving-removal is foreseen.

Then follows a step of shaping the filament obtained. The shaping of the filament is obtained through plastic deformation, cold or hot, and preferably through hammering. Such shaping allows a profile with variable geometry to be obtained, preferably with a circular section, between the first end zone 3 and the second end zone 5, in which each section has an area equal to the desired equivalent area for the end spoke 1.

Then there is an optional intermediate annealing heat treatment to promote the reduction in hardness of the material and to increase its deformability.

One then proceeds to the squashing of the filament in the various sections to obtain the desired end elliptical profiles. The squashing is carried out by cold or hot plastic deformation and can be carried out by molding, through mold and counter mold, or else by lamination, i.e. with the passage of the filament between rollers with suitably shaped surfaces.

Then a further optional intermediate annealing heat treatment is carried out to promote the reduction in hardness of the material and to increase its deformability.

Then there is the step of shaping the widened head 9 of the second end 5 through upsetting, during which the section of the head is progressively increased through axial movement of the material until the desired section is obtained.

One then proceeds to the calibration of the length of the spoke, commonly known as butting, which consists of the trimming of the second end 5 to calibrate the total length of the spoke according to the desired final length of the spoke 1.

Then the filament is subjected to a drawing temper heat treatment to increase the mechanical characteristics, for example a tempering and drawing process should the metallic material of which the spoke consists be steel, or a tempering and ageing process should aluminum be used.

Then the first end 3 is threaded for attachment to the rim 4 which can be carried out by rolling or by shaving-removal according to the area of the pre-selected starting wire, in accordance with that which has been stated previously.

Finally, the spoke obtained from the previous processing is subjected to surface protection treatments, such as anodization or painting, which give the spoke the desired properties of surface protection and the desired aesthetic characteristics.

In general, and according to that which has been described for the two methods, if the section of the starting wire is chosen equal to the equivalent section of the second end zone for attachment to the hub, the shaping of the head is carried out by molding, whereas if the section of the starting wire is smaller than the section of the equivalent section of the second end zone for attachment to the hub, the shaping of the head is carried out by upsetting.

The described methods allow a spoke to be obtained that has sections with different areas, as well as different shapes, along its length. Such methods allow a spoke to be obtained with a small amount of material in its central zone, where the traction stresses are not amplified by local effects related to the attachment to the rim or to the hub.

As far as the manufacturing of the spoke shown and described in FIGS. 9, 10 and from 9a to 9f is concerned, it can be manufactured according to one of the previous methods wherein the squashing step of the various sections of the filament is omitted due to the fact that it must have a substantially circular profile along its entire length.

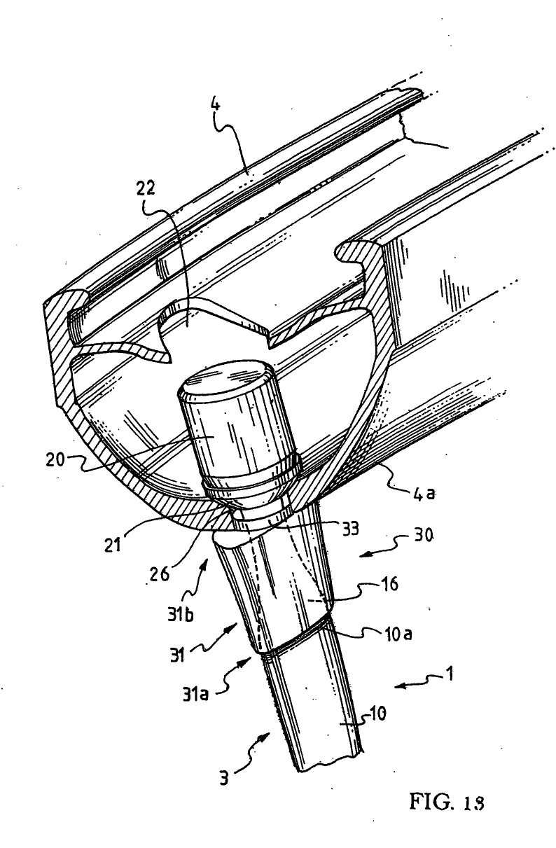

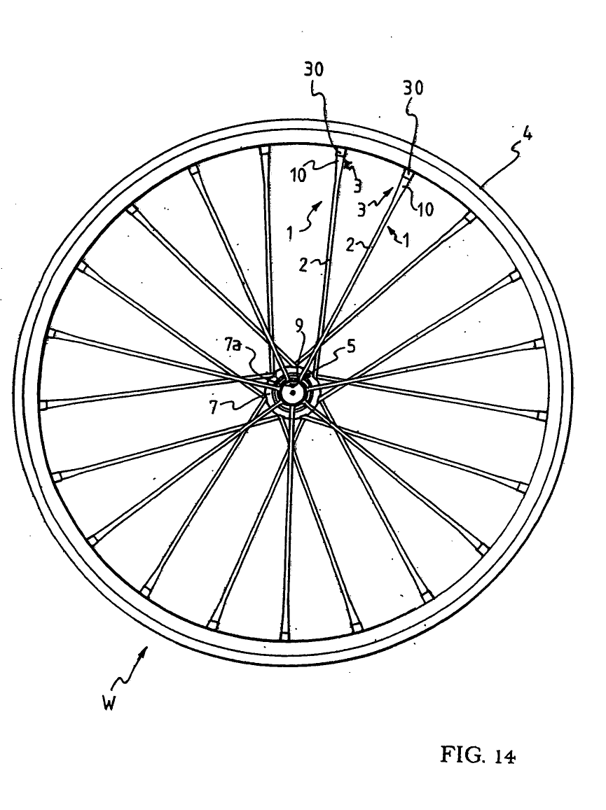

The spoke 1 described above is connected to the rim 4, through its first threaded end zone 3. The attachment of the spoke 1 to the rim 4 of the wheel W must be carried out by keeping the spoke 1 orientated in such a way that the width L of the high visibility zone 10 lies on a plane perpendicular to the axis of the wheel W, or plane of the wheel, in such a way as to be visible to an observer placed at the side of the bicycle. In the embodiment represented here in FIG. 13, the locking of the first end zone 3 to the rim 4 is carried out by using a lock nut 20, arranged resting upon an intermediate plate 21, and positioned inside the rim 4 through its insertion by the upper hole 22.

It is clear, however, that in different embodiments the locking of the spoke 1 could be carried out in a different way, for example through the use of nipples.

As can be seen in FIG. 13, when the spoke 1 is fixed to the rim 4, a sealing element 30 is positioned which wraps around the radial extreme part of the spoke 1, in particular the joining zone 16.

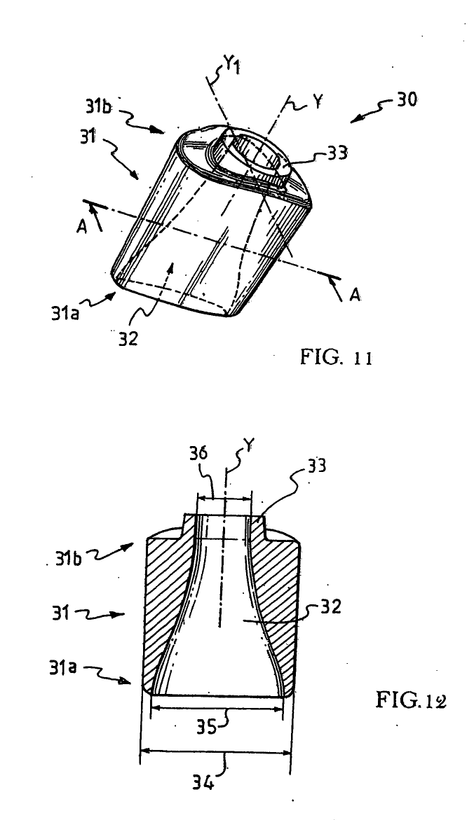

The sealing element 30, as can be seen in particular in FIGS. 11 and 12, has a main body 31 that extends along a main axis Y from a lower end 31a to an upper end 31b and provided with a through hole 32.

The through hole 32 is peripherally closed and is defined by a surface with a shape matching the outer surface of the joining zone 16 of the spoke 1. Such a hole 32 has a decreasing width starting from a maximum area 35 at the lower end 31a of the main body 31 up to a minimum area 36 at the upper end 31b of the main body 31. The maximum area 35 substantially corresponds to the maximum width of the maximum visibility zone 10 (section BB-BB) of the spoke 1, whereas the minimum area 36 corresponds to the diameter of the cylindrical zone (section AA-AA) of the spoke 1.

The main body 31 is substantially prism-shaped and has, along a transversal axis Y1, an increase in width passing from the lower end 31a to the upper end 31b. The outer dimension 34 of the sealing element 30 along the main axis Y, as can be seen in FIG. 12, is kept substantially constant and substantially equal to, or slightly greater than, the maximum width of the spoke 1. In such a way, when the sealing element 30 is mounted on the wheel W, as can be seen in FIG. 13, it defines an extension of the high visibility zone 10 of the spoke 1 up to the inner peripheral surface 4a of the rim 4. This allows the visibility effect of the spoke 1 and of the wheel W to be increased. Moreover, the provision of the sealing element 30 covering the joining zone 16 of the spoke 1, allows the turbulence with air during rotation to be decreased, with beneficial effects on the aerodynamics and on the noisiness of the spoke 1 and of the wheel W.

At the upper end 31b of the main body 31, a collar 33 is also formed, consisting of an annular edge with a substantially circular section which is received with mechanical interference inside the hole 26 crossing the first end zone 3 of the spoke 1. Such a collar 33 allows the hermetic sealing of the hole 26 to be effected, in order to avoid the entry of dirt inside the rim 4.

For such a purpose the sealing element 30 is preferably made of plastic material with resilient properties which ensures a seal as hermetic as possible of the hole 26. Finally, in the attachment step of the spoke 1 to the wheel W, the sealing element 30 makes easier the screwing operations of the nut 20, keeping the spoke 1 firmly in position inside the hole 26.

1. A spoke for a bicycle wheel comprising:
an elongated body that extends along an axis between a first end adapted to be fixed to the rim of the wheel and a second end adapted to be fixed to the hub of the wheel; and
a zone located close to said first end, the zone being of a width greater than the width of a zone close to said second end.

2. A sealing element for a spoke of claim 1 comprising a main body provided with a through hole configured to receive part of said elongated body of said spoke, wherein said through hole is peripherally closed.

3. A sealing element for a spoke of claim 1 comprising a main body provided with a through hole configured to receive part of said elongated body of said spoke, wherein said through hole is defined by a surface with a shape matching the outer surface of said elongated body.

4. A sealing element for a spoke of claim 1 comprising a main body provided with a through hole configured to receive part of said elongated body of said spoke, and a collar formed at an end of said main body and adapted to be inserted in the hole for the attachment of said spoke to said rim.

5. The method for manufacturing a spoke of claim 1, comprising the following steps:
cutting a filament of circular section of predetermined length from a wire of metallic material in an annealed state wherein the area of the section of said wire is equal to the desired area of the cross section of said second end for attachment to the hub;
shaping the filament to obtain a profile with variable geometry between the first end zone and the second end zone;
calibrating the length of the spoke;
carrying out a drawing temper heat treatment to increase the mechanical characteristics of the spoke; and
threading said first end for the attachment to the rim of said spoke.

6. The method for manufacturing a spoke of claim 1, comprising the following steps:
cutting a filament of circular section of predetermined length from a wire of metallic material in an annealed state wherein the area of the section of said wire is equal to the area of the cross section of said first end for attachment to the rim;
shaping the filament to obtain a profile with variable geometry between the first end zone and the second end zone;
calibrating the length of the spoke;
carrying out a drawing temper heat treatment to increase the mechanical characteristics of the spoke; and
threading said first end for the attachment to the rim of said spoke.

7. The spoke of claim 1 wherein said zone of greater width extends along said axis for about one-tenth of the length of the spoke.

8. The spoke of claim 1 wherein said zone of greater width extends along said axis for about one-fifth of the length of the spoke.

9. The spoke of claim 1 wherein said zone of greater width extends along said axis for about one-third of the length of the spoke.

10. The spoke of claim 1 wherein said zone of greater width extends along said axis for about half the length of the spoke.

11. The spoke of claim 1 wherein said zone of greater width extends along said axis for substantially the entire length of the spoke.

12. The spoke of claim 1 wherein said zone of greater width has an increasing progression of the width as it approaches said first end.

13. The spoke of claim 1 wherein said first end for the attachment of the spoke to the rim of the wheel has a section, perpendicular to said axis, that is substantially circular and of a width smaller than said zone of greater width.

14. The spoke of claim 1 further comprising a joining zone located between said zone of greater width and said first end.

15. The spoke of claim 14 wherein said joining zone has a decreasing progression of the width between said zone of greater width and said first end.

16. The spoke of claim 1 wherein said zone of greater width has, on a plane perpendicular to said axis, a section with a flattened profile defining a width and a thickness, the width being larger than said thickness.

17. The spoke of claim 16 wherein said flattened profile is elliptical-shaped.

18. The spoke of claim 16 wherein said width of said flattened profile lies on a plane substantially perpendicular to the axis of the wheel.

19. The spoke of claim 16 wherein said thickness of said zone of greater width has a decreasing progression along said axis in the direction of said first end.

20. The spoke of claim 16 wherein said thickness of said zone of greater width has an increasing progression along said axis in the direction of said first end.

21. The spoke of claim 16 wherein said thickness of said zone of greater width is constant along said axis.

22. The spoke of claim 16 further comprising a cross section with a circular profile in a remaining part with respect to said zone of greater width, on a plane perpendicular to said axis.

23. The spoke of claim 16 further comprising a cross section with a flattened profile in a remaining part with respect to said zone of greater width, on a plane perpendicular to said axis.

24. The spoke of claim 1 wherein said zone of greater width has, on a plane perpendicular to said axis, a cross section with a circular profile.

25. The spoke of claim 24 further comprising a cross section with a circular profile in a remaining part with respect to said zone of greater width, on a plane perpendicular to said axis.

26. The spoke of claim 24 further comprising a cross section with a flattened profile in a remaining part with respect to said zone of greater width, on a plane perpendicular to said axis.

27. The spoke of claim 1 wherein said first end is threaded.

28. The spoke of claim 1 wherein said second end has a widened head adapted to be received in a corresponding seat of said hub.

29. The spoke of claim 28 wherein said widened head has a flattened profile.

30. A sealing element for a spoke of claim 1 comprising a main body provided with a through hole configured to receive part of said elongated body of said spoke.

31. The sealing element of claim 30 wherein said through hole is peripherally closed.

32. The sealing element of claim 30 wherein said through hole is defined by a surface with a shape matching the outer surface of said elongated body.

33. The sealing element of claim 30 further comprising a collar formed at an end of said main body and adapted to be inserted in the hole for the attachment of said spoke to said rim.

34. The sealing element of claim 30 wherein the sealing element is made from a resilient material.

35. A bicycle wheel comprising a plurality of spokes as claimed in claim 1.

36. The wheel of claim 35, further comprising a sealing element of claim 30 arranged between said zone of greater width of said spoke and the inner peripheral surface of said rim of said wheel.

37. The wheel of claim 36 further comprising attachment and/or adjustment means of said spoke to said rim.

38. The wheel of claim 37 wherein the attachment means is a nut.

39. The wheel of claim 37 wherein the attachment means is a nipple.

40. The method for manufacturing a spoke of claim 1, comprising the following steps:
cutting a filament of circular section of predetermined length from a wire of metallic material in an annealed state;
shaping the filament to obtain a profile with variable geometry between the first end zone and the second end zone;
calibrating the length of the spoke;
carrying out a drawing temper heat treatment to increase the mechanical characteristics of the spoke; and
threading said first end for the attachment to the rim of said spoke.

41. The method of claim 40 wherein said step of shaping the filament is carried out by hot or cold plastic deformation.

42. The method of claim 41 wherein said cold plastic deformation is carried out by hammering.

43. The method of claim 40 further comprising a step of squashing said filament after said shaping step of the filament.

44. The method of claim 43 wherein said squashing step is carried out by molding.

45. The method of claim 43 wherein said squashing step is carried out by lamination.

46. The method of claim 40 further comprising a step of shaping said second end to obtain the desired attachment shape to the hub.

47. The method of claim 40 wherein the area of the section of said wire is equal to the desired area of the cross section of said second end for attachment to the hub.

48. The method of claim 40 wherein the area of the section of said wire is equal to the area of the cross section of said first end for attachment to the rim.

49. The method of claim 46 wherein said shaping step of said second end is carried out by molding.

50. The method of claim 46 wherein said shaping step of said second end is carried out by upsetting.

51. The method of claim 40 wherein said threading is carried out by rolling.

52. The method of claim 40 wherein said threading is carried out by shaving-removal.

53. The method of claim 40 further comprising the step of protection treating an end surface.

54. The method of claim 53 wherein said end surface protection treatment is anodisation.

55. The method of claim 53 wherein said end surface protection treatment is painting.

56. The method of claim 40 further comprising intermediate annealing heat treatment steps.

57. A spoke for a bicycle comprising:
an elongated body that extends along an axis between a first end adapted to be fixed to a rim of a wheel and a second end adapted to be fixed to a hub of the wheel; and
a zone located between the ends having a width greater than a width of a zone close to said second end.

58. A spoke for a bicycle wheel comprising:
a first end configured to be attached to a rim of the bicycle wheel;
a second end configured to be attached to a hub of the bicycle wheel; and
an intermediate zone connecting the first end and the second end;
wherein the width of the end of the intermediate zone closer to the first end is greater than the width of the intermediate zone closer to the second end.

59. A spoke for a bicycle wheel comprising:
an elongated body that extends along an axis between a first end adapted to be fixed to a rim of the wheel and a second end adapted to be fixed to a hub of the wheel; and
a zone located close to said first end, the zone being of a width greater than the width of a zone close to said second end;
wherein said zone of greater width extends along said axis for about half the length of the spoke.

60. A spoke for a bicycle wheel comprising:
an elongated body that extends along an axis between a first end adapted to be fixed to a rim of the wheel and a second end adapted to be fixed to a hub of the wheel; and
a zone located close to said first end, the zone being of a width greater than the width of a zone close to said second end;
wherein said zone of greater width extends along said axis for about 80% the length of the spoke.

61. A spoke for a bicycle wheel comprising:
an elongated body that extends along an axis between a first end adapted to be fixed to a rim of the wheel and a second end adapted to be fixed to a hub of the wheel; and
a zone located close to said first end, the zone being of a width greater than the width of a zone close to said second end;
wherein said zone of greater width has an increasing progression of the width as it approaches said first end.

62. A spoke for a bicycle wheel comprising:
an elongated body that extends along an axis between a first end adapted to be fixed to a rim of the wheel and a second end adapted to be fixed to a hub of the wheel;
a zone located close to said first end, the zone being of a width greater than the width of a zone close to said second end; and
a joining zone located between said zone of greater width and said first end.

63. A spoke for a bicycle wheel comprising:
an elongated body that extends along an axis between a first end adapted to be fixed to a rim of the wheel and a second end adapted to be fixed to a hub of the wheel; and
a zone located close to said first end, the zone being of a width greater than the width of a zone close to said second end;
wherein said zone of greater width has, on a plane perpendicular to said axis, a section with a flattened profile defining a width and a thickness, the width being larger than said thickness.

64. A spoke for a bicycle wheel comprising:
an elongated body that extends along an axis between a first end adapted to be fixed to a rim of the wheel and a second end adapted to be fixed to a hub of the wheel; and
a zone located close to said first end, the zone being of a width greater than the width of a zone close to said second end;
wherein said zone of greater width has, on a plane perpendicular to said axis, a section with a circular profile.

65. A spoke for a bicycle wheel comprising:
an elongated body that extends along an axis between a first end adapted to be fixed to a rim of the wheel and a second end adapted to be fixed to a hub of the wheel;
a zone located close to said first end, the zone being of a width greater than the width of a zone close to said second end, wherein said zone of greater width has, on a plane perpendicular to said axis, a cross section with a circular profile; and
a cross section with a flattened profile in a remaining part with respect to said zone of greater width, on a plane perpendicular to said axis.
